(19) United States
(12) Patent Application Publication
(10) Pub. No.: US 2023/0332742 A1
(43) Pub. Date: Oct. 19, 2023

(54) METHOD FOR COATING A WALL

(71) Applicant: ADDITIVE SPACE GMBH, Neusaess (DE)

(72) Inventor: Sascha Larch, Neusaess (DE)

(21) Appl. No.: 18/138,061

(22) Filed: Apr. 22, 2023

Related U.S. Application Data
(63) Continuation of application No. PCT/EP2021/079132, filed on Oct. 20, 2021.

(30) Foreign Application Priority Data
Oct. 22, 2020 (DE) DE102020127874.8
Oct. 22, 2020 (DE) DE202020106328.6
Nov. 6, 2020 (DE) DE102020129355.0

(51) Int. Cl. B32B 5/02; B32B 37/24; B32B 27/12; C23C 4/06; F17C 1/06; B32B 5/26; B32B 1/02

(52) U.S. Cl. CPC F17C 1/06; B32B 1/02; B32B 5/024; B32B 5/026; B32B 5/028; B32B 5/26; B32B 27/12; B32B 37/24; C23C 4/06; B32B 2037/243; B32B 2250/02; B32B 2255/02; B32B 2255/205; B32B 2262/0269; B32B 2262/101; B32B 2262/106; B32B 2262/12; B32B 2305/18; B32B 2313/04; B32B 2315/085; B32B 2377/00; F17C 2201/0109; F17C 2201/032; F17C 2203/0604; F17C 2203/0607; F17C 2203/0619; F17C 2203/0639; F17C 2203/0646; F17C 2203/0651; F17C 2203/0663; F17C 2205/0103; F17C 2209/225; F17C 2209/232; F17C 2221/011; F17C 2221/012; F17C 2221/017; F17C 2270/0105; F17C 2270/0168; F17C 2270/0197

(57) ABSTRACT

A method for coating a wall with a metallic surface layer, the wall including an outer wall layer formed from or including a plastic material or a fiber composite material, the method comprising: in a first step providing a wall base body formed by the outer wall layer; therafter in a second step bonding the outer wall layer to an intermediate layer formed from or including a fiber composite material to form the wall to be coated, wherein fibers of the fiber composite material of the intermediate layer include a metallic surface, wherein fibers of the fiber composite material of the intermediate layer connected to the outer wall layer include a non-metallic fiber core coated with a metal or a metal alloy; and thereafter in a third step coating the wall with the metallic surface layer on a surface of the intermediate layer facing away from the outer wall layer.

### RELATED APPLICATIONS

This application is a continuation of International Application PCT/EP2021/079132 claiming priority from German patent application 10 2020 127 874.8 filed on Oct. 22, 2020, German utility model application 20 2020 106 328.6 filed on Oct. 22, 2020, and from German patent application 10 2020 129 355.0 filed on 06 Nov. 2020, all of which are incorporated in their entirety by this reference.

### FIELD OF THE INVENTION

The present invention relates to a method for coating a wall, as well as to a wall which has advantageously been manufactured according to this method. In a particular embodiment, the invention relates to a method for producing a container having such a wall, as well as to a container advantageously manufactured according to this method. One technical field in which this special variant of the method according to the invention, directed to the manufacture of containers, is applied is the manufacture of pressure vessels such as, for example, pressure tanks.

### BACKGROUND OF THE INVENTION

It is often necessary to coat a wall body with a metal surface. Thermal spraying, in which metal is sprayed onto a surface and forms a mechanical bond with the material of this surface, is particularly suitable for this purpose. In addition to thermal spraying methods, in which the metal impinges on the surface to be coated in a molten -i.e. hot - state, cold gas spraying has recently become established, in which solid metal particles are sprayed onto the surface to be coated with high kinetic energy, melting as a result of the impact energy and bonding with the material of the surface to be coated.

However, not every surface material is suitable for such thermal spraying methods, since, for example, easily meltable or mechanically sensitive surface materials can be impaired or damaged as a result. This is particularly undesirable if the impaired property of the surface material is an essential property for the intended use of the wall body, such as its strength.

One particular area in which such walls can be used is the manufacture of special pressure vessels made of pressure-resistant plastic materials, so-called “composite overwrapped pressure vessels” (COPV). Such vessels are used in particular in aerospace technology as pressure tanks, for example as fuel pressure tanks, but are also used, for example as fuel pressure tanks, for example hydrogen tanks, in land, air and water vehicles. For weight reasons, such tanks are often made of plastic, in particular a fiber composite material, in order to be able to effectively support the forces generated by the pressure difference between the pressurized tank interior and the environment, which in space applications is regularly a vacuum, despite the low weight of the material. The same applies to tanks whose interior is under negative pressure relative to the environment (for example, aircraft wastewater tanks). However, such tanks with walls made of plastic or a fiber composite material are often not chemically resistant to the gases or liquids to be stored or (especially in the case of helium or hydrogen) are not sufficiently leakproof.

Therefore, such pressure tanks today usually consist of a thin metallic liner wrapped with the fiber composite and bonded by adhesive to secure the liner against bursting. One problem here is that the metallic liner and the fiber composite are subject to different thermal expansions and shrinkages due to the large temperature differences prevailing in space or, as a result of filling with cryogenic propellants, are already subject to strong temperature changes and variations when the pressure tank is filled. The liner, which is made of titanium, for example, is formed from sheets (for example, from two drawn hemispheres as a dome and a bent sheet with a longitudinal seam as a cylinder) and welded, including the connecting flanges. The surface of the metallic liner usually must be prepared and primed prior to the bonding and wrapping process to ensure adequate bonding of the fiber composite to the surface of the metallic liner. Then the container, initially formed only by the liner, is pressurized for stabilization, and wrapped or otherwise surrounded with the fiber composite and cured.

Particularly in the case of negative pressure inside the container, but also in the case of frequent temperature fluctuations over large temperature ranges, as regularly occurs in space travel, there is nevertheless a risk that the metallic liner will detach from the surrounding structure of the fiber composite wall and collapse or tear.

Although the above-mentioned thermal coating methods of thermal spraying have been known for a long time, the liners made of sheet metal described above are still provided for lining containers, especially pressure tanks.

DE 197 47 384 A1 discloses a method for the production of composite bodies in which a base body consisting, for example, of plastic or ceramic is coated with a layer of metal by thermal spraying using the cold gas spraying method in order to strengthen the mechanical stability of the base body or make it gas-tight or vacuum-tight.

DE 197 47 386 A1 also discloses a method for the thermal coating of substrate materials, for example also of composite materials, with, for example, a metal or a metal alloy by means of cold gas spraying.

A method for the application of surface protective coatings of plastic is known from CH 538 549 A, in which a body to be coated has a wall of a fiber-synthetic resin composite. An intermediate layer of a fabric with longitudinal and transverse threads laminated with the synthetic resin is first applied to this fiber-synthetic resin composite. A surface protection layer of metallic or ceramic materials is applied to this intermediate layer by flame spraying.

### BRIEF SUMMARY OF THE INVENTION

It is an object of the present invention to design a method for coating a wall provided with a fiber composite material with at least one metallic surface layer in such a way that, when coating the wall by means of thermal spraying, the surface to be coated and the layer belonging to this surface are not impaired and, even when only a very thin coating layer is applied, this adheres effectively and reliably to the surface to be coated, and to specify a correspondingly coated wall. In addition, a corresponding method for manufacturing a container having such a wall is to be suggested, by means of which it can be achieved that, with a low total weight of a container to be manufactured, the latter is and remains reliably gas-tight as well as chemically inert and resistant even in the case of large temperature and/or pressure fluctuations. A corresponding container is also to be specified.

The part of the object directed to the method for coating a wall is achieved by a method for coating a wall comprising an outer wall layer with at least one metallic surface layer, according to the first alternative comprises the following steps:
a) providing a wall base formed by the outer wall layer;
b) bonding the outer wall layer to an intermediate layer formed of or comprising a fiber composite material to form the wall to be coated, at least a portion of the fibers of the fiber composite material of the intermediate layer having a metallic surface, and
b) coating the wall on the surface of the intermediate layer facing away from the outer wall layer with the at least one metallic surface layer by means of a spraying device by thermal spraying. Advantageously, this is done by cold gas spraying.

According to the second alternative, the wall to be coated formed in steps a) and b) is produced in a slightly modified manner, for which purpose the following steps are provided instead of steps a) and b) before step c):
a1) application of an intermediate layer or the outer wall layer to at least one mold body;
b1) applying the outer wall layer of the fiber composite material to the intermediate layer or applying the intermediate layer to the outer wall layer and bonding the outer wall layer to the inner intermediate layer to form the wall to be coated, at least some of the fibers of the fiber composite material of the intermediate layer having a metallic surface;
b2) Curing of the wall.

Thus, to form the wall to be coated, either the intermediate layer is applied to a provided wall base body (first alternative) or the outer wall layer is applied to the intermediate layer previously applied to a mold body (first variant of the second alternative) or the intermediate layer is applied to the outer wall layer previously applied to a mold body (second variant of the second alternative). Consequently, the first two steps of the second alternative can also be carried out in reverse order, so that first the outer wall layer is applied to at least one mold body and then the intermediate layer is applied to the outer wall body, and only then curing takes place.

As a result of the fact that, in the second alternative, in step b1) the wall layer is applied to the intermediate layer applied in step a1) and not yet or not yet fully cured (or vice versa), the plastic material of the intermediate layer combines ideally with the matrix material of the fiber composite of the outer wall layer and cures together in step b2) to form an integral wall. After curing, the mold body is removed and the wall is then coated according to step c). In principle, however, it is also possible and encompassed by the invention to alternatively cure the inner intermediate layer first before applying the outer wall layer.

By spraying the surface coating onto the intermediate layer by means of a thermal spraying method, such as thermal spraying, in particular cold gas spraying, this surface coating can be applied to the wall in an extremely thin yet intensively adhering manner, thus forming a wafer-thin metallic liner. This not only results in a significant mass saving compared with conventional metal cladding of such a wall with a metal liner made of sheet metal, but also saves costly sheet metal forming, welding and surface preparation work. In addition, the intensive adhesion of the surface coating sprayed by means of the thermal spray method ensures an intimate bond between the surface coating and the wall, especially if the latter is made of plastic or a fiber composite material, and significantly reduces the risk of the surface coating detaching from the wall because the metal particles penetrate into the surface of the intermediate layer and form a mechanical positive-locking connection.

Another major advantage of the method according to the invention compared with prior art plating with a liner made of sheet metal is that, in the event of defects detected during quality control (for example, undercoating thickness or scratches in the surface coating), repairs to the surface coating forming the liner can be carried out without difficulty by repeated spraying. It is also possible to carry out subsequent improvements if, for example, the results of a qualification test indicate that local reinforcement of the metallic surface layer may be necessary.

The design of the intermediate layer from or with a fiber composite material with fibers laminated in synthetic resin, of which at least some of the individual fibers have a metallic surface layer, ensures a high impact strength of the surface of the fibers, which reduces the risk of damage to the individual fibers on impact of the metal particles sprayed on during thermal spraying, especially during cold gas spraying, in step c). The strength of the wall body is thus not or only slightly affected.

The surface coating with metallic material by means of thermal spraying in step c) causes an intimate microscopic interlocking structural connection of the metallic surface coating with the metallic fiber surfaces due to the (partial) penetration of the metal particles sprayed onto the metallic fiber surface of the intermediate layer. In addition, the adhesion of the sprayed-on metal particles to the metallic surface of the fibers is better than for fibers with a non-metallic surface.

The intermediate layer, which is firmly bonded to the outer wall layer, protects the outer wall layer, in particular the fibers responsible for its strength, from damage by metal particles impinging on the intermediate layer during thermal spraying, for example on an internal side of a container body having the wall, and possibly even penetrating into it. Sprayed-on metal particles thus penetrate the intermediate layer at most in order to firmly anchor themselves and thus the metallic surface coating in the intermediate layer.

To ensure that a firm connection is also created between the outer wall layer and the intermediate layer, the matrix of the intermediate layer advantageously contains the same plastic material as the outer wall layer. This is particularly advantageous if the outer wall layer consists of or comprises a fiber composite material and if the plastic material of the intermediate layer corresponds to the matrix material of this fiber composite material of the outer wall layer.

Further advantageous and advantageous features of the methods according to the invention for coating a wall are the subject of dependent claims

It is also advantageous if the outer wall layer is formed from or has a plastic or fiber composite material.

Advantageously, the intermediate layer has a fiber composite fabric or a fiber composite scrim, or it is formed from a fiber composite fabric or a fiber composite scrim.

It is also of particular advantage if at least some of the individual fibers of the fiber composite of the intermediate layer have a non-metallic fiber core coated with a metal or metal alloy.

Advantageously, at least part of the individual fibers of the fiber composite of the intermediate layer is coated with copper, with nickel or with a thermal expansion invariant alloy of metals.

It is also of particular advantage if the intermediate layer is formed from a fiber composite material in prepreg design.

In a advantageous variant of the methods according to the invention, which can be combined with other variants, the respective fiber composite is a carbon fiber composite, an aramid fiber composite, or a glass fiber composite.

An advantageous embodiment of the respective method according to the invention, which can be combined with other embodiments of the method, is characterized in that for forming the surface coating at least one of the metals aluminum, titanium, stainless steel, copper or nickel and/or at least one alloy of metals, such as, for example, an iron-nickel alloy, advantageously a thermal expansion invariant iron-nickel alloy, such as is known, for example, under the protected trademark Invar®, is applied by the thermal spray method, in particular and advantageously by cold gas spraying.

It is particularly advantageous if the wall of the wall base body is formed in step a) from a fiber composite material in prepreg construction or in wet lay-up construction. These manufacturing methods of the wall ensure high mechanical stability, so that the thin metallic surface coating has to absorb virtually no mechanical loads and/or strains.

It can also be advantageous if the wall is formed from or comprises a ductile matrix plastic. In this case, the risk of the plastic being impaired in its strength by the impact and penetration of metal particles during thermal spraying, in particular cold gas spraying, is significantly reduced.

This advantage can also be obtained if the wall is formed as a laminate, in particular if the laminate is formed by or comprises a short fiber laminate or if the laminate is formed by or comprises a sheet molding compound.

In both alternative methods of the invention, the intermediate layer is formed by or has a fiber composite material, the fiber composite material advantageously being formed by a fiber composite fabric impregnated with a plastic matrix and having, for example, carbon fibers, glass fibers, aramid fibers (for example, from Kevlar® or Nomex®) or other fibers. This type of intermediate layer is particularly advantageous if the outer wall is formed from or has a fiber composite with unidirectional fibers. By providing the intermediate layer with a fiber composite fabric, the metal particles impinging due to the spraying method and forming a permanent bond with the wall will build up better resistance and, at the same time, the risk of damage to the, for example, unidirectionally oriented fibers of the outer wall layer will be reduced just as significantly as a risk formed by possible preliminary damage to the unidirectionally oriented fibers of the outer wall layer, since the fiber composite fabric of the inner intermediate layer already forms a form fit and has a biaxial load-bearing behavior even without the matrix plastic.

The fibers with the metallic surface layer are advantageously glass fibers, aramid fibers or carbon fibers, which have advantageously been coated, for example vapor-deposited, with a metal on their respective surface prior to lamination or prior to processing into the fiber composite in question. However, it can also be fibers made of another base material that have been provided with the metallic surface layer.

At least part of the individual fibers is advantageously coated with a metal or a metal alloy, for example by vapor deposition or CVD (chemical vapor deposition), prior to the manufacture of the fiber fabric, the fiber knit or the fiber scrim, in particular already during or after the manufacture of the fibers.

The part of the object directed to the wall is solved by the features of claim 10, namely by a wall having an outer wall layer as well as an intermediate layer which is provided on one side of the outer wall layer and is connected thereto and which is formed from a fiber composite material or has a fiber composite material, at least some of the fibers of the fiber composite material of the intermediate layer having a metallic surface, the surface of the intermediate layer facing away from the outer wall layer being provided with at least one metallic surface layer applied by thermal spraying, advantageously by cold gas spraying.

This wall is thereby advantageously produced according to a method of the invention. Even if it is sufficient if only some of the fibers, i.e., some of the fibers, of the intermediate layer are metal-coated on their respective surface, advantageously all fibers of the fiber composite of the intermediate layer are coated with a metal or a metal alloy.

Advantageously, the fiber composite of the interlayer has a fiber fabric, a fiber knit or a fiber scrim with the metal-coated fibers or is formed from a fiber fabric, a fiber knit or a fiber scrim with the metal-coated fibers. In this case, all of the fibers of the fiber fabric, the fiber knit or the fiber scrim, respectively, or only some of the fibers may be provided with a metallic surface, for example be metal-coated. Advantageously, in the case of a fiber fabric, both fibers of the fabric oriented in a first direction and fibers of the fabric oriented in a second direction at an angle to the first direction are provided with a metallic surface.

Advantageously, at least a portion of the individual fibers of the fiber composite of the interlayer is coated with copper, with nickel, or with a thermal expansion invariant alloy of metals.

It is also advantageous if the fiber composite is a carbon fiber composite, an aramid fiber composite, or a glass fiber composite.

The individual metal-coated fibers advantageously have a non-metallic fiber core, for example of fiberglass, aramid fiber or carbon fiber material, and a metallic outer surface, the metal advantageously being or comprising copper or nickel or a thermal expansion invariant alloy of metals. However, other metals or metal alloys may also be provided for coating the fibers.

The metallic surface layer of the wall applied by the thermal spray method has at least one of the metals aluminum, titanium, stainless steel, copper, or nickel and/or at least one alloy of metals, such as an iron-nickel alloy.

The application of at least one — advantageously thin — metallic layer to the wall of fiber-reinforced composite (FRC) or of another non-metallic material by means of a thermal spraying method, in particular by means of cold gas spraying, in accordance with the invention serves to improve the basic properties of the material of the wall. The following basic properties are improved as a result:
the chemical compatibility, for example with liquid oxygen;
the permeability or impermeability, for example to hydrogen or helium;
the thermal properties and
the mechanical properties.

A major technological challenge solved by the inventor in solving the object consisted — in addition to ensuring the desired layer thickness of the surface coating and its properties (for example, strength, surface texture, homogeneity, etc.) — in overcoming sometimes contradictory requirements regarding:
sufficient adhesion of the sprayed metallic surface coating to the wall and
to prevent damage to the substrate material (for example, the fiber composite or the plastic of the wall.

The part of the object directed to the method for manufacturing a container is solved according to a first variant by a method for manufacturing a container and according to a second variant by a container.

In the first variant of the method according to the invention for manufacturing a container with a container body having a wall according to the invention, the wall is formed according to one of the methods according to the invention described above. The container body is provided with at least one opening and the intermediate layer is located on the internal side of the outer wall layer facing the internal side of the container body. The coating of the wall of the container body with the at least one metallic surface layer is carried out on the surface of the intermediate layer facing the internal side of the container body by means of a spraying device introduced through the at least one opening by thermal spraying, advantageously by cold gas spraying.

This method variant is used if the container body is made in one piece or if a multi-part container body has already been assembled before coating. The container body can be manufactured first, if necessary, already with connecting flanges, and then the metallic surface coating can be sprayed onto the internal side of the container.

According to the invention, this method variant for manufacturing a container with a container body having a wall, wherein the container body is provided with at least one opening, thus comprises the following steps:
a) manufacturing the container body with a wall which has an outer wall layer made of plastic or of a fiber composite material and an inner intermediate layer formed by a fiber composite material on the internal side of the outer wall layer facing the internal side of the container body, at least some of the fibers of the fiber composite material of the inner intermediate layer being coated with a metal or a metal alloy;
b) coating the wall of the container body on the surface of the inner intermediate layer facing the internal side of the container body with at least one metallic surface layer by means of a spraying device introduced through the opening by thermal spraying. Advantageously, this is done by cold gas spraying.

The second variant of the method according to the invention for producing a container with a multipart container body formed from container parts, which has a wall according to the invention, wherein the container body is provided with at least one opening, has the following steps:
a) producing the container parts of the container body each having a wall formed according to a method for producing a wall according to the invention, wherein the intermediate layer lies on the internal side of the outer wall layer facing the internal side of the container body, and wherein the coating of the wall of the respective container part of the container body takes place on the surface of the inner intermediate layer facing the internal side of the container body, and
b) assembling the container parts to the container.

This alternative method variant is advantageously applicable if the container body is designed in several parts. In this case, the individual container parts are first manufactured and the respective surface coating is sprayed onto their respective internal sides, and then the container parts are assembled to form the container.

It is particularly advantageous if the wall of the container body or the wall of the individual container parts is made of a fiber composite material in prepreg design or in wet-wound design. These manufacturing methods of the wall ensure high mechanical stability, so that the thin metallic surface coating has to absorb virtually no pressure-difference-related or temperature-difference-related loads and/or elongations.

It can also be advantageous if the wall of the container body or of the individual container parts is formed from or comprises a ductile matrix plastic. In this case, the risk of the plastic being impaired in its strength by the impact and penetration of metal particles during thermal spraying, in particular cold gas spraying, is significantly reduced.

This advantage can also be achieved if the wall of the container body is formed as a laminate, in particular when the laminate is formed by or comprises a short fiber laminate or if the laminate is formed by or comprises a sheet molding compound.

Advantageously, at least some of the individual fibers of the fiber composite fabric of the inner interlayer are coated with copper, with nickel or with a thermal-expansion-invariant alloy of metals.

It is of particular advantage when the inner intermediate layer comprises or is formed from a fiber composite fabric.

Advantageously, the wall of the container body or of the respective container part is formed from a fiber composite material in the following sub steps:
a1) Application of the inner intermediate layer to at least one mold part;
a2) Application of the outer wall layer made of the fiber composite material to the inner intermediate layer;
a3) Curing of the wall.

As a result of the fact that in step a2) the wall layer is applied to the intermediate layer applied in step a1) and not yet or not yet completely cured, the plastic material of the intermediate layer — as already in the first variant — combines in an ideal manner with the matrix material of the fiber composite of the outer wall layer and cures together in step a3) to form an integral wall. After curing, the mold body is removed from the container body formed in this way, for example melted out, disassembled or stress-relieved, and coating of the wall from the internal side then follows. In principle, however, it is also possible and encompassed by the invention to alternatively cure the inner intermediate layer first before applying the outer wall layer.

Advantageously, the inner intermediate layer is also formed here by a fiber composite fabric impregnated with a plastic matrix and comprising, for example, carbon fibers, glass fibers, aramid fibers (for example from Kevlar® or Nomex®) or other fibers. This type of intermediate layer is particularly advantageous if the outer wall is formed from or has a fiber composite material with unidirectional fibers. By providing the intermediate layer with a fiber composite fabric, the metal particles impinging due to the spraying method, which must form a permanent bond with the wall, will build up better resistance and at the same time the risk of damage to the unidirectionally aligned fibers of the outer wall layer is reduced just as significantly as a risk formed by possible preliminary damage to the unidirectionally aligned fibers of the outer wall layer, since the fiber composite fabric of the inner intermediate layer already forms a form fit even without the matrix plastic and has a biaxial load-bearing behavior.

Particularly advantageously, the methods of the invention are used to manufacture a container when the fiber composite is a carbon fiber composite or a glass fiber composite.

An advantageous embodiment of the methods of the invention for producing a container, which can be combined with other embodiments of the method, is characterized in that for forming the surface coating at least one of the metals aluminum, titanium, stainless steel, copper or nickel and/or at least one alloy of metals, such as, for example, iron-nickel alloys, advantageously thermal expansion invariant iron-nickel alloys, such as are known, for example, under the protected trademark Invar®, is applied by the thermal spray method, in particular by cold gas spraying.

The part of the object directed to the container is solved by the features of claim 18, namely by a container with a container body which has a wall formed according to the invention with an outer wall layer of plastic or of a fiber composite material and an inner intermediate layer formed by a fiber composite material on the internal side of the outer wall layer facing the internal side of the container body, at least some of the fibers of the fiber composite material of the inner intermediate layer being coated with a metal or a metal alloy, the surface of the inner intermediate layer facing the internal side of the container body being provided with at least one metallic surface layer applied by thermal spraying, in particular by cold gas spraying, by means of the coating method according to the invention. Even if only some of the fibers, i.e., some of the fibers, of the inner intermediate layer can be metal-coated on their respective surface, advantageously all fibers of the fiber composite of the inner intermediate layer are coated with a metal or a metal alloy.

Advantageously, the fiber composite material of the inner intermediate layer of the container wall has a fiber composite fabric, a fiber composite knit or a fiber composite scrim with the metal-coated fibers or consists of such a fiber composite fabric, fiber composite knit or fiber composite scrim. In this case, all of the fibers of the fiber fabric or fiber knitted fabric or only some of the fibers may be metal-coated. Advantageously, in the case of a fiber fabric, both fibers of the fabric extending in a first direction and fibers of the fabric extending in a second direction at an angle to the first direction are metal coated.

The individual fibers are coated with a metal or metal alloy, for example vapor deposited or coated by CVD (chemical vapor deposition), before the fiber fabric or fiber knit is made. The individual metal-coated fibers have a non-metallic fiber core, for example of fiberglass or carbon fiber material, and a metallic outer surface, the metal advantageously being or comprising copper or nickel or a thermal expansion invariant alloy of metals. However, other metals or metal alloys may also be provided for coating the fibers.

In particular, the container according to the invention forms a pressure tank which is used, for example, in space technology as a satellite or rocket tank. Likewise, the container according to the invention can be used as a pressure tank for fuels in land, air, or water vehicles. However, the container according to the invention can also be used as a pressure tank for breathing gases, as required, for example, for so-called “space walks” (Extra Vehicular Activities - EVA) in or on space suits or on earth during diving or for breathing protection purposes and for the supply of breathing air in the fire department, the military or in disaster control.

By spraying the surface coating onto the wall, in this case onto the internal side of the wall of the container, by means of a thermal spraying method, such as thermal spraying, in particular cold gas spraying, this surface coating can be applied to the wall (in this case of the container) in an extremely thin yet intensively adhering manner, thus forming a wafer-thin metallic liner. This not only results in a significant mass saving compared with the conventional production of a container with a metal liner made of sheet metal, but also eliminates the need for costly sheet metal forming, welding, and surface preparation work. In addition, the intensive adhesion of the surface coating sprayed by means of the thermal spray method ensures an intimate bond between the surface coating and the wall of the container, especially if this is made of plastic or a fiber composite material, and significantly reduces the risk of the surface coating detaching from the container wall, as the metal particles penetrate the surface of the container wall and form a mechanical positive connection.

Another major advantage of the method according to the invention over the lining of a container with a liner made of sheet metal, as known from the prior art, is that in the event of defects detected during quality control (for example, lower wall thickness or scratches in the surface coating), repair measures on the surface coating forming the liner can be carried out without difficulty by repeated spraying. It is also possible to carry out subsequent improvements if, for example, the results of a qualification test show that local reinforcements of the metallic liner may be required on the subsequent flight model.

The intermediate layer on the internal side of the container, which is firmly bonded to the outer wall layer, protects the outer wall layer, in particular the fibers responsible for its strength (for example the metal-coated carbon fibers or glass fibers), from damage by metal particles hitting the internal side of the container body during thermal spraying and possibly even penetrating into it. Sprayed-on metal particles thus penetrate at most into the interlayer in order to firmly anchor themselves and thus the metallic surface coating in the interlayer.

### BRIEF DESCRIPTION OF THE DRAWINGS

The invention is now described with based on advantageous embodiment with reference to drawing figures, wherein:

FIG. 1 illustrates a partially cut container body with a wall according to the invention during the coating step according to an advantageous variant of the method according to the invention and

FIG. 2 illustrates the container body shown in section in FIG. 1 during the step of coating the wall by means of cold gas spraying.

### DETAILED DESCRIPTION OF THE INVENTION

The method according to the invention for coating a wall 12 and the wall 12 according to the invention are described below by way of example using the wall 12 of a container 1, for example a pressure tank for a gaseous fuel. However, the method according to the invention and the wall according to the invention are independent of the intended use and application of the wall 12 and are not limited to the wall of a container, such as a pressure tank. In this respect, the container 1 shown here is only one of many examples having a wall constructed and coated as described below.

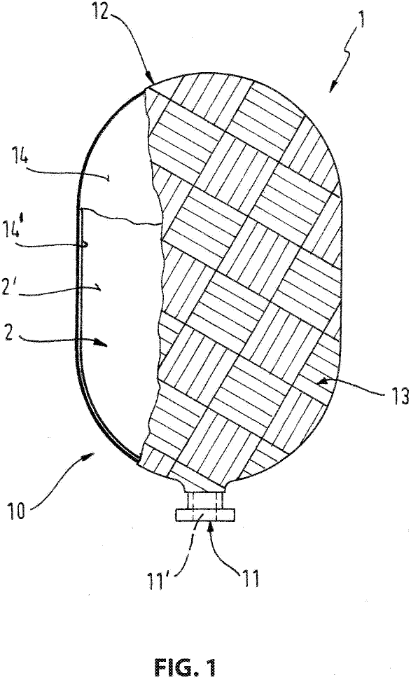

In FIG. 1, a container body 10 of a container 1 is shown in the phase of manufacturing the container body 10. The wall 12 of the container body 10 consists of an outer wall layer 13, which in the example shown consists of a fiber composite material with unidirectionally oriented fibers with a cross-winding, and an inner wall layer, also referred to as an intermediate layer 14, which also consists of a fiber composite material whose matrix material corresponds substantially to the matrix material of the fiber composite material of the outer wall layer 13.

To manufacture the container body 10, a mold body 2 is first provided onto which the inner wall layer 14 is applied. The inner wall layer 14 has a fiber composite material, for example a fiber composite fabric or fiber composite knitted fabric with a liquid, curable resin as matrix material, which is for example first painted or sprayed onto the mold body 2 — which is advantageously provided with a parting agent — and to which the fiber composite fabric or fiber composite knitted fabric is then applied. However, the fiber composite fabric or fiber composite knitted fabric can also be present, for example, in the form of so-called prepregs and applied to the mold body 2 in the uncured state. The wall layer, also referred to as intermediate layer 14, thus forms a closed plastic layer as a fiber composite layer enveloping the surface 2′ of the mold body 2.

As long as the intermediate layer 14 has not yet cured or has not yet fully cured, an outer wall layer 13 made of a further fiber composite material with unidirectionally oriented fibers is applied to the intermediate layer 14 forming the inner wall layer, and advantageously the mold body 2 provided with the intermediate layer 14 is wrapped with this unidirectional fiber composite material. Since the resin matrix of the fiber composite material of the outer wall layer 13 essentially corresponds to the matrix material of the intermediate layer 14 — advantageously the same resin is used here — the two wall layers 13, 14 form a close bond and ideally crosslink with each other.

In order to create access to the later hollow container body 10, a connecting flange 11 provided with a through opening 11′ can be laminated into the wall 12 of the container body 10 in the course of the production of the two wall layers 13, 14. In the example shown, such a connecting flange 11 is provided on the underside of the container body 10 shown in FIG. 1. This connecting flange can, for example, be made of a metal or also of plastic, fiber composite material or also of ceramic.

After the wall 12 has been built up over the mold body 2 in the manner described, the container body 10 is cured in a manner known per se to the skilled person. After curing, the mold body 2 is removed from the interior of the container body 10 through the opening 11′ in the connecting flange 11, for example the mold body 2 is melted out of the container body 10.

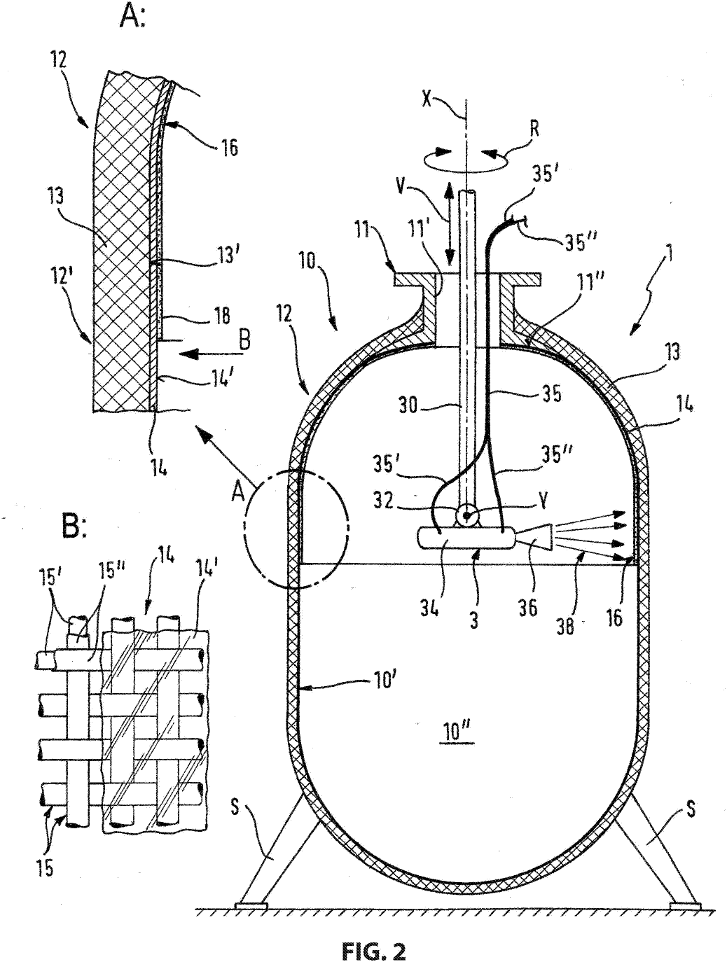

The hollow container body 10 manufactured in this way is then subjected to the coating method according to the invention shown in connection with FIG. 2, in which a surface coating 16 is applied by means of a thermal spraying method, in the example shown by means of cold gas spraying, to the inner surface 14′ of the inner wall layer forming the intermediate layer 14, i.e. to the internal side 10′ of the container body 10 facing the interior 10″ of the container 1.

In FIG. 2, the container body 10 shown in FIG. 1 is shown with the connecting flange 11 erected upwards, the container 1 being supported in a stable standing position on a base by means of supports S. The container 1 is shown in a vertical section in order to be able to show the method of coating the internal side 10′ of the container body 10.

In FIG. 2, it can be seen how the connecting flange 11, which is made of metal, for example, is laminated into the wall 12 of the container body 10 and is firmly connected to the wall 12. For example, the connecting flange 11 is anchored with its collar between the inner wall layer 14 and the outer wall layer 13 by lamination. Alternatively, however, the collar of the connecting flange 11 can also be covered on its outer side with the inner wall layer 14 and the outer wall layer 13.

Through the opening 11′ of the connecting flange 11, a spraying device 3 for a thermal spraying method is inserted from above into the interior 10″ of the container body 10. The spraying device 3 comprises a guide rod 30 which can be moved in the vertical direction by means of a control and guide mechanism (not shown), as illustrated by the double arrow V in FIG. 2, and which can be rotated about its axis X in both directions by means of the actuating and control mechanism, as symbolized by the rotation double arrow R in FIG. 2.

At the lower end of the guide rod 30 projecting into the container body 10, an injection unit 34 for the thermal spraying method is pivotably mounted by means of a swivel joint 32, which can be swiveled about a transverse axis Y at right angles to the axis X of the guide rod 30. A supply hose unit 35, which is likewise guided through the opening 11′ of the connection flange 11 into the interior 10″ of the container body 10, is functionally coupled to the injection unit 34 and connects the injection unit 34 to (not shown) supply sources for a working gas and to a supply of powdered particles, in the present case powdered metal particles, which are sprayed by the injection device 3 onto the surface 14′, facing the interior 10″, of the intermediate layer 14 on the internal side 10′ of the container body 10. For this purpose, the supply hose unit 35 has a working gas hose 35′ and a particle transport hose 35″. The injection unit 34 has at least one spray nozzle 36 through which metal material can be applied by means of a spray jet 38 to the internal side 10′ of the container body, namely to the inner surface 14′ of the intermediate layer 14 in one coating layer 18 or in several coating layers, thereby forming the surface coating 16.

In the shown example of the present invention, the injection unit 34 is a unit known per se for cold gas spraying. In the cold gas spraying method for coating surfaces, a working gas supplied to the injection unit 34 is first compressed and heated and then accelerated by expansion in the spray nozzle 36, whereby particles introduced into the gas jet, in the present case metal particles, are shot onto a, advantageously previously heated, substrate - in the present case onto the surface 14′ of the intermediate layer 14. There, the particles partially penetrate the surface 14′ to be coated and thus anchor the applied coating layer 18 of the surface coating 16 in the intermediate layer 14 forming the inner wall layer.

The layered structure of the wall 12 according to the invention with the wall base body 12′ formed by the outer wall layer 13, the intermediate layer 14 bonded to the latter and consisting of the fabric with fibers 15 with a metallic surface layer 15″ (detail B) and the coating layer 18 applied to the intermediate layer 14 by means of cold gas spraying and forming the surface coating 16 can be clearly seen in the enlarged representation of detail A in FIG. 2.

Detail B in FIG. 2 shows an enlarged view of a partially cut top view of the intermediate layer 14 in the direction of the arrow B. The surface 14′ of the intermediate layer 14 is predominantly formed by the resin matrix covering the fibers 15 of the fiber composite of the intermediate layer 14, shown here as a fabric. The individual fibers 15 have a fiber core 15′, for example of carbon fiber, aramid fiber or glass fiber material, which is coated, for example vapor-deposited, with a metal on its surface, so that the individual fibers of the woven (or knitted) fabric of the intermediate layer 14 are provided with a metallic surface layer 15″. Advantageously, the metallic surface layer 15″ is made of copper or nickel or of a metal alloy which is advantageously heat expansion invariant. Such a thermal expansion invariant iron-nickel alloy is known, for example, under the proprietary trade name Invar®.

As can be seen in FIG. 2, in the example shown, just under the upper half of the container body 10 including the inner surface 11″ of the connecting flange 11 facing the interior 10″ (or the part of the intermediate layer 14 lying thereon) has already been coated by the spraying device 3 with the surface coating 16 from the metal particles supplied. The surface coating 16 thus also covers the so-called shank area of the connecting flange 11. The metal particles applied by means of cold gas spraying form a closed, homogeneous surface coating 16 which in the finished state — even if the lower part of the container body 10 will still be provided with the surface coating 16 —surrounds the interior 10″ of the container body 10 (except for the opening 11′ in the connecting flange 11).

Due to the rotatability of the spraying device 3 about the vertical axis X corresponding to the rotation double arrow R, the vertical displaceability of the spraying device 3 corresponding to the double arrow V and the swiveling of the spraying unit 34 about the transverse axis Y, the nozzle 36 can be directed to any location of the internal side 10′ of the container body′ so that the internal side 10′ of the container body′ 10 can be coated without gaps by means of the thermal spraying method, i.e. in this case cold gas spraying, and thus forms a closed and gas-tight surface coating 16.

The surface coating 16 may comprise a single layer applied once, or a plurality of successively applied layers of the same metal material or of different metal materials.

If the container is provided with at least one inner bulkhead which divides the interior of the container into two (or more) separate compartments (for example to accommodate different fuel components), this bulkhead, which consists for example of a glass fiber composite material or carbon fiber composite material, is also provided with a metallic surface coating on at least one of its surfaces (advantageously on both surfaces) by the method according to the invention. As a result, both spaces inside the container are completely provided with the metallic surface coating on all surfaces of their respective internal sides.

The application of the method is particularly advantageous if the container body is made in one piece. The wall of the container body can be manufactured first, if necessary, already with connecting flanges, and then the metallic surface coating can be sprayed onto the internal side of the wall of the container.

However, the method can also be used if the container body is made up of several parts. In this case, the individual container parts, i.e., individual walls, are first manufactured and the respective surface coating is sprayed onto their respective internal sides, and then the container parts (walls) are assembled to form a container.

Reference signs in the description and the drawings serve only for a better understanding of the invention and do limit the scope of the invention which is defined in the appended patent claims.

REFERENCE NUMERALS AND DESIGNATIONS

| | |
|---|---|
| 1 | container |
| 2 | mold body |
| 2′ | surface of the mold body |
| 3 | spraying device |
| 10 | container body |
| 10 ′ | internal side of the container body |
| 10 ″ | interior |
| 11 | connection flange |
| 11′ | opening |
| 11 ″ | inner surface |
| 12 | wall |
| 12′ | wall base body |
| 13 | wall layer |
| 13′ | internal side |
| 14 | intermediate layer |
| 14′ | surface |
| 15 | intermediate layer fiber |
| 15′ | fiber core (e.g., carbon fiber, aramid fiber, glass fiber) |
| 15 ″ | metallic surface layer of the fiber |
| 16 | surface coating |
| 18 | coating layer |
| 30 | bar |
| 32 | pivot joint |
| 34 | injection unit |
| 35 | supply hose unit |
| 35′ | working gas hose |
| 35″ | particle transport hose |
| 36 | spray nozzle |
| 38 | spray jet |
| 110 | vessel body |
| R | rotation double arrow |
| S | supports |
| V | double arrow |
| X | vertical axis |
| Y | transverse axis |

What is claimed is:

1. A method for coating a wall with a metallic surface layer, the wall including an outer wall layer formed from or including a plastic material or a fiber composite material, the method comprising:
in a first step providing a wall base body formed by the outer wall layer; therafter
in a second step bonding the outer wall layer to an intermediate layer formed from or including a fiber composite material to form the wall to be coated,
wherein fibers of the fiber composite material of the intermediate layer include a metallic surface,
wherein fibers of the fiber composite material of the intermediate layer connected to the outer wall layer include a non-metallic fiber core coated with a metal or a metal alloy; and thereafter
in a third step coating the wall with the metallic surface layer on a surface of the intermediate layer facing away from the outer wall layer by a spraying device by thermal spraying.

2. A method for coating a wall formed from a fiber composite material with a metallic surface layer, the wall including an outer wall layer formed from or including a plastic or a fiber composite material, the method comprising:
in a first step applying an intermediate layer formed from a fiber composite material or including a fiber composite material or the outer wall layer to a mold body; thereafter
in a second step applying the outer wall layer of the fiber composite material to the intermediate layer or applying the intermediate layer to the outer wall layer and bonding the outer wall layer to an interior of the intermediate layer to form the wall to be coated, wherein fibers of the fiber composite material of the intermediate layer include a metallic surface; thereafter
in a third step curing the wall; and thereafter
in a fourth step coating the wall on a surface of the intermediate layer facing away from the outer wall layer with the metallic surface layer by a spraying device by thermal spraying,
wherein individual fibers of the fiber composite material of the intermediate layer applied to the mold body in the first step or applied to the outer wall layer in the second step include a non-metallic fiber core coated with a metal or a metal alloy.

3. The method according to claim 1, wherein the intermediate layer includes a fiber composite fabric or a fiber composite scrim or is formed from a fiber composite fabric or a fiber composite scrim.

4. The method according to claim 1, wherein individual fibers of the fiber composite material of the intermediate layer are coated with copper, with nickel, or with a heat-expansion-invariant alloy of metals.

5. The method according to claim 1, wherein the fiber composite material is a carbon fiber composite material, an aramid fiber composite material or a glass fiber composite material.

6. The method according to claim 1, wherein at least one of the metals aluminum, titanium, stainless steel, copper or nickel or at least one alloy of metals is applied by the thermal spray process to form the metallic surface layer.

7. The method according to claim 1, wherein the wall is formed as a laminate.

8. A wall coated according to the method according to claim 1, the wall comprising: the outer wall layer; and
the intermediate layer provided on one side of the outer wall layer and bonded thereto,
wherein the outer wall layer is formed from or includes the plastic material or the fiber composite material, the intermediate layer is formed from or inlcudes the fiber composite material, fibers of the fiber composite material of the intermediate layer include the metallic surface and and include the non-metallic fiber core coated with the metal or the metal alloy, the surface of the intermediate layer facing away from the outer wall layer is provided with the metallic surface layer applied by the thermal spraying.

9. The wall according to claim 8, wherein the fiber composite material of the intermediate layer includes a fiber fabric, a fiber knit or a fiber scrim or is formed from a fiber fabric, a fiber knit or a fiber scrim.

10. The wall according to claim 8, wherein the individual fibers of the fiber composite of the intermediate layer are coated with copper, with nickel or with a heat-expansion-invariant alloy of metals.

11. The wall according to claim 10, wherein the fiber composite material is a carbon fiber composite, an aramid fiber composite or a glass fiber composite.

12. The wall according to claim 8, wherein the metallic surface layer includes least one of the metals aluminum, titanium, stainless steel, copper or nickel or at least one alloy of metals or an iron-nickel alloy.

13. A method for producing a container including a container body including the wall formed according to the method according to claim 1,
wherein the container body includes an opening, wherein the intermediate layer is located on an internal side of the outer wall layer facing an internal side of the container body, the method comprising:
performing the coating of the wall of the container body with the metallic surface layer on the surface of the inner intermediate layer facing towards the internal side of the container body by the thermal spraying by the spraying device introduced through the opening.

14. A method for manufacturing a container including a container body formed from container parts and including an opening, the method comprising:
producing the container parts of the container body, each container part including a wall formed according to the method according to claim 1,
wherein the intermediate layer is arranged on on an internal side of the outer wall layer facing towards an internal side of the container body, and
wherein the coating of the wall of the container parts of the container body with the metallic surface layer is performed on the surface of the inner intermediate layer facing towards the internal side of the container body; and
assembling the container parts to form the container.

15. A container, comprising:
a container body, including
the wall according to claim 8, including
the outer wall layer made from the plastic or the fiber composite material, and
the inner intermediate layer formed by a fiber composite material on the internal side of the outer wall layer facing the internal side of the container body,
wherein a portion of the fibers of the fiber composite material of the inner intermediate layer is coated with a metal or a metal alloy,
wherein the surface of the inner intermediate layer facing the internal side of the container body is provided with a metallic surface layer applied by thermal spraying according to the method according to claim 1.

16. The method according to claim 2, wherein the intermediate layer includes a fiber composite fabric or a fiber composite scrim or is formed from a fiber composite fabric or a fiber composite scrim.

17. The method according to claim 2, wherein individual fibers of the fiber composite material of the intermediate layer are coated with copper, with nickel, or with a heat-expansion-invariant alloy of metals.

18. The method according to claim 2, wherein the fiber composite material is a carbon fiber composite material, an aramid fiber composite material or a glass fiber composite material.

19. The method according to claim 2, wherein at least one of the metals aluminum, titanium, stainless steel, copper or nickel or at least one alloy of metals is applied by the thermal spray process to form the metallic surface layer.

20. The method according to claim 2, wherein the wall is formed as a laminate.
